(19) United States
(12) Patent Application Publication
(10) Pub. No.: US 2021/0283831 A1
(43) Pub. Date: Sep. 16, 2021

(54) 3-D PRINTING PROCESS FOR FORMING FEED CONE FOR MICROWAVE ANTENNA

(71) Applicant: CommScope Technologies LLC, Hickory, NC (US)

(72) Inventor: Craig Mitchelson, Cumbernauld (GB)

(21) Appl. No.: 16/334,679

(22) PCT Filed: Sep. 21, 2017
(86) PCT No.: PCT/US2017/052615

§ 371 Date: Mar. 19, 2019

(51) Int. Cl. B29C 64/147; H01Q 19/19; B33Y 10/00; B33Y 80/00

(52) U.S. Cl. CPC B29C 64/147; H01Q 19/193; B29K 2705/00; B33Y 80/00; B33Y 10/00

(57) ABSTRACT

A method of forming a feed cone for a microwave antenna includes the steps of: providing a digitized design for a feed cone, the feed cone comprising a plurality of geometric features that vary in area along an axial dimension of the feed cone; subdividing the digitized design into a plurality of thin strata stacked in the thickness dimension; forming a thin layer of material corresponding to one of the thin strata; fixing the thin layer of material; and repeating steps (c) and (d) to form a feed cone.

### RELATED APPLICATION

The present application claims priority from and the benefit of U.S. Provisional Patent Application No. 62/398,115, filed Sep. 22, 2016, the disclosure of which is hereby incorporated herein in its entirety.

### FIELD OF THE INVENTION

The present invention is directed generally to microwave antenna components, and more specifically to the manufacture of microwave antenna components,

### BACKGROUND

Feed cones are typically a critical component in a microwave antenna design. The role of a feed cone (or, in some instances, the “feed”) is to efficiently radiate the transmitted signal from a radio onto a reflector to produce a highly focussed “pencil” beam propagating in a single direction. In a receive mode, the feed collects energy from a distant source as it is reflected off an associated parabolic reflector to a focal point and transfers this energy back to the radio through a waveguide.

Current feeds are typically complex structures. They are ordinarily formed of a single low loss dielectric material with a metalized reflective surface. These parts are predominately machined from rods of material or injection-molded.

### SUMMARY

As a first aspect, embodiments of the invention are directed to a method of forming a feed cone for a microwave antenna. The method comprises the steps of: (a) providing a digitized design for a feed cone, the feed cone comprising a plurality of geometric features that vary in area along an axial dimension of the feed cone; (b) subdividing the digitized design into a plurality of thin strata stacked in the thickness dimension; (c) forming a thin layer of material corresponding to one of the thin strata; (d) fixing the thin layer of material; and (e) repeating steps (c) and (d) to form a feed cone.

As a second aspect, embodiments of the invention are directed to a feed cone formed by the method described above.

### BRIEF DESCRIPTION OF THE FIGURES

FIG. 1 is a perspective, partial section view of a microwave antenna with a feed cone according to embodiments of the invention.

FIG. 2 is an enlarged perspective, partial section view of the feed cone of FIG. 1.

FIG. 3 is a section view of a feed cone and waveguide of FIG. 2.

### DETAILED DESCRIPTION OF EMBODIMENTS OF THE INVENTION

The present invention will now be described more fully hereinafter, in which embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

Unless otherwise defined, all terms (including technical and scientific terms) used herein have the same mean as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. The device may be otherwise oriented (rotated 90 degrees or at other orientations) and the spatially relative descriptors used herein interpreted accordingly.

Well-known functions or constructions may not be described in detail for brevity and/or clarity.

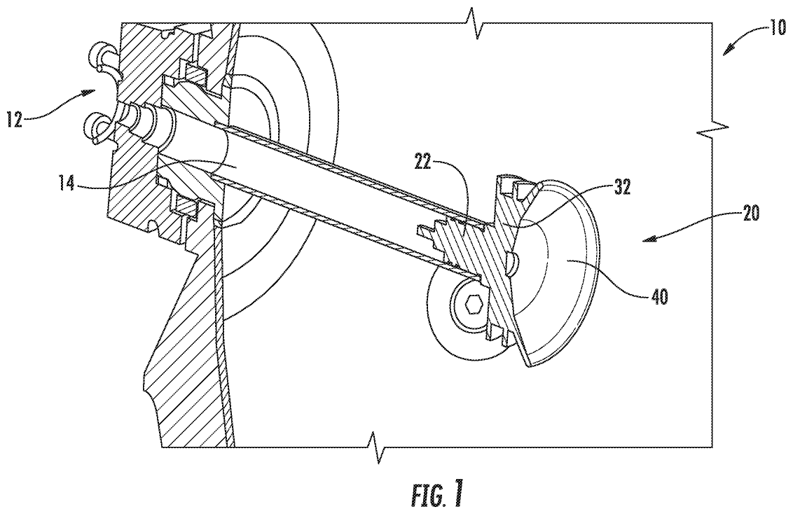

Referring now to the figures, a microwave antenna assembly, designated broadly at 10, is shown in FIG. 1. The microwave antenna assembly 10 includes, inter alia, an input/output connection 12, a waveguide run 14, and a feed cone 20. The input/output connection 12 and waveguide run 14 may be of conventional construction and need not be described in detail herein. The feed cone 20 shown herein is exemplary; the ensuing discussion refers to the feed cone 20, but is applicable to other feed cones as well.

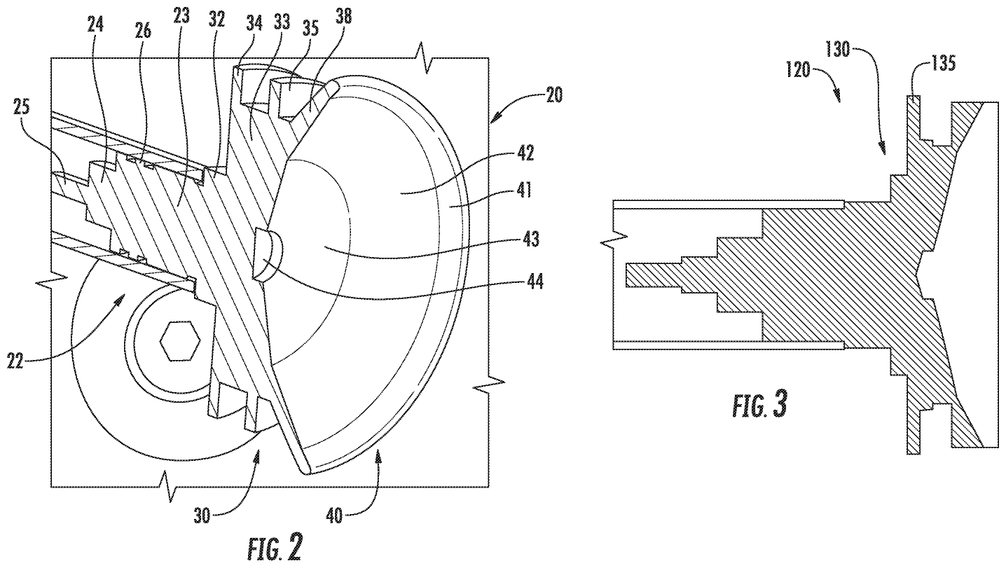

As discussed above, feed cones typically have a complex configuration. As can be seen in FIGS. 1 and 2, the feed cone 20 has a neck 22 that fits within one end of the waveguide 14. The neck 22 has a stepped configuration, with three different collinear cylindrical “steps” 23, 24 25, that decrease in diameter as they extend farther into the waveguide 14. The step 23 includes circular ridges 26. The feed cone 20 also includes a main body 30 that has two additional “steps” 32, 33 of increasing diameter. The main body 30 also includes two circular flanges 34, 35 that extend from step 33 and an angled rim 38. A reflective surface 40 (which is typically metalized) is divided into three rings 41, 42, 43 and a central recess 44 that define generally a parabolic conical surface.

Molding the feed cone 20 would require a complicated mold in order to form the features of the feed cone 20 (e.g., the gaps between the flanges 34, 35 and the rim 38). Alternatively, the feed cone 20 may be machined in a time-consuming machining process.

Another feed cone, designated at 120, is shown in FIG. 3. The feed cone 120 has a stepped profile like that of the feed cone 20, but includes only one flange 135 on the main body 130, and also includes more “steps” in its profile. Manufacturing the feed cone 120 would raise similar issues to the manufacture of the feed cone 20.

Given the complicated configuration of a typical feed cone, manufacturing of a feed cone may be facilitated through the use of a three-dimensional (3D) printing process. With this technique, the three-dimensional structure of a substrate (in this instance the entire feed cone, with all of its steps, ridges, flanges and recesses) is digitized via computer-aided solid modeling or the like. The coordinates defining the substrate are then transferred to a device that uses the digitized data to build the substrate. Typically, a processor subdivides the three-dimensional geometry of the substrate into thin “slices” or layers. Based on these subdivisions a printer or other application device then applies thin layers of material sequentially to build the three-dimensional configuration of the substrate. Some methods melt or soften, then harden, material to produce the layers, while others cure liquid materials using different methods to form, then fix, the layers in place. 3D printing techniques are particularly useful for items that vary in area along the axial dimension (i.e., the dimension that is normal to the thin “slices”).

One such technique involves the use of a selective laser, which can employed in either selective laser sintering (SLS) or selective laser melting (SLM). Like other methods of 3D printing, an object formed with an SLS/SLM machine starts as a computer-aided design (CAD) file. CAD files are converted to a data format (e.g., an .stl format), which can be understood by a 3D printing apparatus. A powder material, such as a metal or polymer, is dispersed in a thin layer on top of the build platform inside an SLS machine. A laser directed by the CAD data pulses down on the platform, tracing a cross-section of the object onto the powder. The laser heats the powder either to just below its boiling point (sintering) or above its melting point (melting), which fuses the particles in the powder together into a solid form. Once the initial layer is formed, the platform of the SLS machine drops—usually by less than 0.1 mm—exposing a new layer of powder for the laser to trace and fuse together. This process continues again and again until the entire object has been formed. When the object is fully formed, it is left to cool in the machine before being removed.

Another 3D printing technique is multi-jet modeling (MJM). With this technique, multiple printer heads apply layers of structural material to form the substrate. Often, layers of a support material are also applied in areas where no material is present to serve as a support structure. The structural material is cured, then the support material is removed. As an example, the structural material may comprise a curable polymeric resin or a fusable metal, and the support material may comprise a paraffin wax that can be easily melted and removed.

Another such technique is fused deposition modeling (FDM). Like MJM, this technique also works on an “additive” principle by laying down material in layers. A plastic filament or metal wire is unwound from a coil and supplies material to an extrusion nozzle which can turn the flow on and off. The nozzle is heated to melt the material and can be moved in both horizontal and vertical directions by a numerically controlled mechanism, directly controlled by a computer-aided manufacturing (CAM) software package. The model or part is produced by extruding small beads of material to form layers; typically, the material hardens immediately after extrusion from the nozzle, such that no support structure is employed.

Still other techniques of additive manufacturing processes include stereolithography (which employs light-curable material and a precise light source), laminated object manufacturing, metal are welding, wire feed additive manufacturing, binder jetting, electron beam melting, blown powder, metal and binder, welding and other emerging technologies.

After the feed cone is formed via a 3D printing process of a low loss dielectric material, the reflective, metallic surface 40 can be applied. This can be performed either in a 3D printing process also, or by conventional metallization techniques.

Irrespective of which 3D printing technique is employed, there are multiple potential advantages for the production of a feed cone. First, the complex geometry of the feed cone can be formed in one automated operation, and the geometry can be changed by simply reprogramming the printer. This capability can provide great manufacturing flexibility.

Second, in the past feed the geometries of feed cones have been limited by manufacturing limitations; for example, a machining or molding operation would render it difficult, if not impossible, to create internal voids in a monolithic component. As a result, in some instances performance of the feed cone may have been compromised due to these manufacturing constraints. With 3D printing of feed cones, internal voids in specific regions may be easily created that can improve performance.

Third, 3D printing may provide the opportunity to form a monolithic component in a single operation that includes more than one material, and in particular that includes materials with different dielectric constants and/or electrical conductivities. As one example, it may be worthwhile to include internal metallic areas or regions within a polymeric matrix of a feed cone.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A method of forming a feed cone or a microwave antenna, comprising the steps of:
(a) providing a digitized design for a feed cone, the feed cone comprising a plurality of geometric features that vary in area along an axial dimension of the feed cone;
(b) subdividing the digitized design into a plurality of thin strata stacked in the thickness dimension;
(c) forming a thin layer of material corresponding to one of the thin strata;
(d) fixing the thin layer of material; and
(e) repeating steps (c) and (d) to form a feed cone.

2. The method defined in claim 1, wherein the geometric features include at least one radially-extending flange.

3. The method defined in claim 1, wherein the geometric features include an internal void.

4. The method defined in claim 1, wherein the thin layer of material comprises a polymeric material.

5. The method defined in claim 1, wherein the material is a first material, and wherein the method further comprises the steps of forming a thin layer of a second material corresponding to one of the thin strata and fixing the thin layer of the second material, the second material differing from the first material.

6. The method defined in claim 5, wherein the second material differs in dielectric constant from the first material.

7. The method defined in claim 6, wherein the first material is a polymeric material, and the second material is a metallic material.

8. The method defined in claim 1, wherein step (d) comprises fusing the thin layer.

9. The method defined in claim 1, further comprising the step of applying a metal layer to a reflective surface of the feed cone after step (e).

10. A feed cone formed by the method of claim 1.

11. The feed cone defined in claim 10, wherein the geometric features include at least one radially-extending flange.

12. The feed cone defined in claim 10 or claim 11, wherein the geometric features include an internal void.

13. The feed cone defined in claim 10, wherein the thin layer of material comprises a polymeric material.

14. The feed cone defined in claim 10, wherein the material is a first material, and wherein the feed cone further comprises thin layers of a second material corresponding to one of the thin strata, the second material differing from the first material.

15. The feed cone defined in claim 14, wherein the second material differs in dielectric constant from the first material.

16. The feed cone defined in claim 15, wherein the first material is a polymeric material, and the second material is a metallic material.

17. The feed cone defined in claim 10, further comprising a metal layer applied to a reflective surface of the feed cone.
